(19) United States
(12) Patent Application Publication
(10) Pub. No.: US 2021/0365871 A1
(43) Pub. Date: Nov. 25, 2021

(54) INFORMATION PROCESSING APPARATUS AND JOB SCHEDULING METHOD

(71) Applicant: FUJITSU LIMITED, Kawasaki-shi (JP)

(72) Inventor: Shigeto SUZUKI, Kawasaki (JP)

(73) Assignee: FUJITSU LIMITED, Kawasaki-shi (JP)

(21) Appl. No.: 17/223,342

(22) Filed: Apr. 6, 2021

(30) Foreign Application Priority Data
May 25, 2020 (JP) 2020-090589

(51) Int. Cl. G06Q 10/06

(52) U.S. Cl. CPC G06Q 10/063116; G06Q 10/06315

(57) ABSTRACT

The process includes determining execution timings of a plurality of jobs stored in a plurality of queues, respectively, in each of a plurality of time zones, based on priorities that correspond to the plurality of queues, and an order in which the plurality of jobs are stored in the plurality of queues, when at least one of values that indicate progress statuses that correspond to the plurality of queues included in a group that has a higher priority of a priority of queues than other groups among the plurality of groups is less than a threshold value.

### CROSS-REFERENCE TO RELATED APPLICATION

This application is based upon and claims the benefit of the prior Japanese Patent Application No. 2020-090589, filed on May 25, 2020, the entire contents of which are incorporated herein by reference.

### FIELD

The embodiments discussed herein are related to an information processing apparatus and a job scheduling method.

### BACKGROUND

As an example, a business operator who provides a service to a user (hereinafter, also simply referred to as a business operator) constructs a business system required for providing the service. Then, in such a business system, the business operator operates, for example, a job scheduler that performs an execution time determination of each job, etc.

Specifically, when, for example, a new job is input, the job scheduler specifies a node capable of executing the new job, based on information such as a job execution status in each node. Then, in this case, the job scheduler instructs any of specified nodes to execute the new job.

Related technologies are disclosed in, for example, Japanese Laid-Open Patent Publication Nos. 64-067630 and 04-178740.

### SUMMARY

According to an aspect of the embodiments, a non-transitory computer-readable recording medium having stored a job scheduling program that causes a computer to execute a process, the process includes storing a plurality of jobs to be executed in a plurality of queues according to maximum execution times of the plurality of jobs and numbers of nodes used when the plurality of jobs are executed, dividing the plurality of queues into a plurality of groups according to the numbers of nodes, specifying second queues which are queues other than a first queue with a high priority among the plurality of queues included in each of the plurality of groups in each of a plurality of time zones included in a time zone during which the plurality of jobs are executed, determining, in each of the plurality of time zones, a priority of the second queues to be different priorities lower than a priority of the first queue, for the plurality of groups, respectively, calculating, for each of the plurality of queues, a first progress value that indicates a progress status of execution of the plurality of jobs stored in each queue, based on a first value which is a number of the plurality of jobs to have stored in each queue in a predetermined time zone, and a second value which is a number of the plurality of jobs to have executed in the predetermined time zone, and determining execution timings of the plurality of jobs stored in the plurality of queues, respectively, in each of the plurality of time zones, based on priorities that correspond to the plurality of queues, and an order in which the plurality of jobs are stored in the plurality of queues, when at least one of second progress values that indicate progress statuses that correspond to the plurality of queues included in a group that has a higher priority of the second queues than other groups among the plurality of groups is less than a first threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating the configuration of an information processing system;

FIG. 2 is a view illustrating a specific example of scheduling of each job;

FIG. 3 is a view illustrating the specific example of scheduling of each job;

FIG. 4 is a view illustrating the specific example of scheduling of each job;

FIG. 5 is a view illustrating the specific example of scheduling of each job;

FIG. 6 is a view illustrating the specific example of scheduling of each job;

FIG. 7 is a view illustrating a specific example when each worker executes jobs;

FIG. 8 is a view illustrating the hardware configuration of the information processing apparatus;

FIG. 9 is a block diagram of functions of the information processing apparatus;

FIG. 10 is a flowchart illustrating the outline of a job scheduling process in a first embodiment;

FIG. 11 is a view illustrating the outline of the job scheduling process in the first embodiment;

FIG. 12 is a flowchart illustrating details of the job scheduling process in the first embodiment;

FIG. 13 is a flowchart illustrating details of the job scheduling process in the first embodiment;

FIG. 14 is a flowchart illustrating details of the job scheduling process in the first embodiment;

FIG. 15 is a flowchart illustrating details of the job scheduling process in the first embodiment;

FIG. 16 is a flowchart illustrating details of the job scheduling process in the first embodiment;

FIG. 17 is a flowchart illustrating details of the job scheduling process in the first embodiment;

FIG. 18 is a flowchart illustrating details of the job scheduling process in the first embodiment;

FIG. 19 is a flowchart illustrating details of the job scheduling process in the first embodiment;

FIG. 20 is a view illustrating a specific example of priority information;

FIG. 21 is a view illustrating a specific example of the priority information;

FIG. 22 is a view illustrating jobs to be distributed to queues;

FIG. 23 is a view illustrating jobs to be distributed to queues;

FIG. 24 is a view illustrating jobs to be distributed to queues;

FIG. 25 is a view illustrating a specific example of progress status information;

FIG. 26 is a view illustrating a specific example of execution status information;

FIG. 27 is a view illustrating a specific example of schedule information; and

FIG. 28 is a view illustrating details of the job scheduling process in the first embodiment.

### DESCRIPTION OF EMBODIMENTS

A worker who executes a job (hereinafter, also simply referred to as a worker) executes, for example, jobs having different execution times in each of time zones. Specifically, for example, the worker repeatedly executes a job having a relatively short execution time within working hours, and executes a job having a relatively long execution time immediately before the end of the working hours. Accordingly, the worker is capable of organizing, for example, confirmation timings of job execution results within the working hours as much as possible, and is capable of efficiently performing jobs, including job execution.

However, a job scheduler performs, for example, a scheduling on the execution timing of each job according to the priority of each job. Thus, even when a job has a relatively short execution time, the turnaround time (a total time of an execution waiting time and an execution time) may be relatively long.

The estimated turnaround time of each job is calculated at the time when each job is input to the job scheduler. Thus, the worker many not acquire in advance the estimated turnaround time before each job is input.

Therefore, the worker may not efficiently perform jobs, including the execution result confirmation of each job.

Hereinafter, an embodiment of techniques capable of shortening the turnaround time of a job in a specific time zone will be described with reference to the accompanying drawings.

### Configuration of Information Processing System

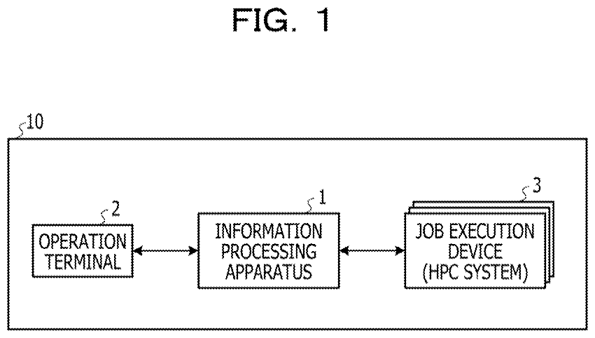

First, the configuration of an information processing system 10 will be described. FIG. 1 is a view illustrating the configuration of the information processing system 10.

The information processing system 10 includes an information processing apparatus 1 in which a job scheduler that performs scheduling of a job execution timing is operated, and an operation terminal 2 by which a worker performs necessary operations. The information processing system 10 includes a job execution device 3 that executes jobs according to the scheduling performed by the information processing apparatus 1.

The job execution device 3 is a device configured by a plurality of nodes (a plurality of physical machines), and is, for example, a high performance computing (HPC) system. The operation terminal 2 is a terminal that is capable of accessing the information processing apparatus 1 via a network (not illustrated) such as the Internet.

Specifically, the worker inputs, for example, a job as an execution target, to the information processing apparatus 1 via the operation terminal 2. The worker inputs, for example, the number of nodes used for job execution, or the execution time of each job to the information processing apparatus 1 through the operation terminal 2.

Then, the information processing apparatus 1 transmits the job as the execution target input from the operation terminal 2, to the job execution device 3. The information processing apparatus 1 generates information indicating a schedule related to an execution timing of the execution target job (hereinafter, also referred to as schedule information) based on each information piece input from the operation terminal 2, and transmits the information to the job execution device 3.

Next, the job execution device 3 executes the execution target job according to the schedule information transmitted from the information processing apparatus 1. Hereinafter, the job scheduling performed in the information processing apparatus 1 will be described.

### Specific Example of Job Scheduling

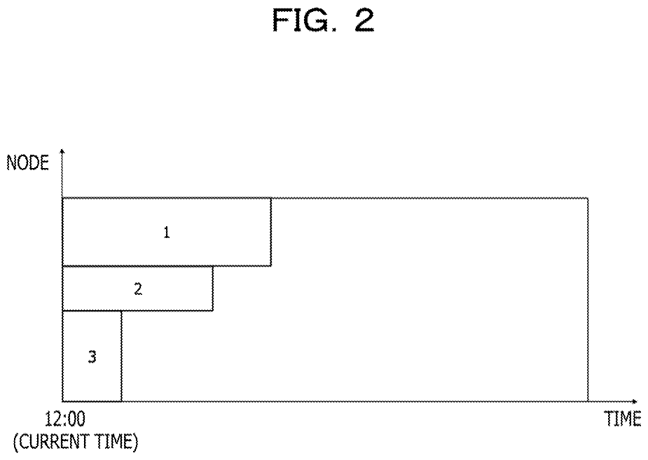

FIGS. 2 to 6 are views illustrating a specific example of job scheduling. The horizontal axis and the vertical axis in the example illustrated in FIGS. 2 to 6 indicate a time when each job is executed and an execution node of each job, respectively. In the example illustrated in FIGS. 2 to 6, the horizontal axis length of a rectangle corresponding to each job corresponds to a turnaround time of each job. Hereinafter, the descriptions will be made assuming that the current time is 12:00.

In the job scheduling, for example, as illustrated in FIG. 2, the information processing apparatus 1 performs the scheduling such that a job with a priority of “1” (hereinafter, also referred to as a job 1), a job with a priority of “2” (hereinafter, also referred to as a job 2), and a job with a priority of “3” (hereinafter, also referred to as a job 3) are executed at the same time. That is, the information processing apparatus 1 performs scheduling so as to execute as many jobs as possible in parallel in a descending order of the job priority.

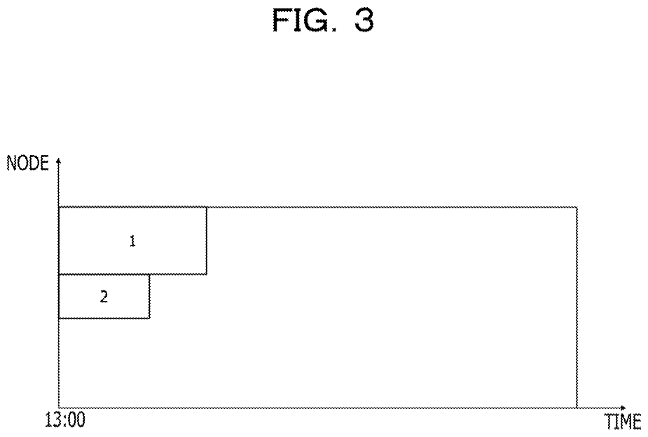

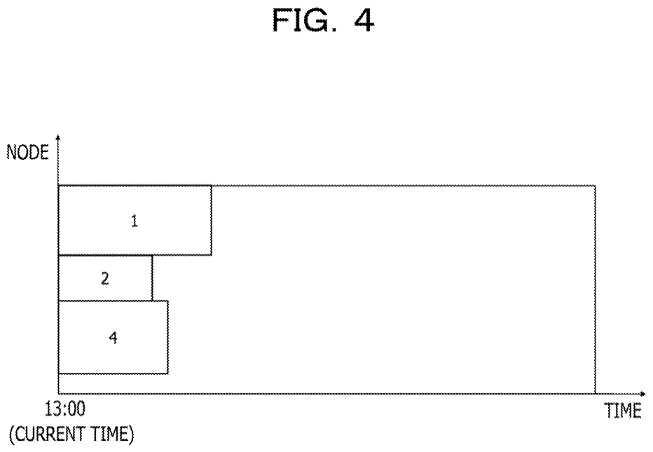

Then, for example, as illustrated in FIG. 3, when a free node is generated at a point in time after one hour (13:00) along with the end of the execution of the job 3, for example, as illustrated in FIG. 4, the information processing apparatus 1 performs scheduling such that a job with a priority of “4” (hereinafter, also referred to as a job 4) is executed at the generated free node. That is, in this case, the information processing apparatus 1 performs scheduling such that the job 4 which is a job with the highest priority among unexecuted jobs is executed.

Accordingly, the information processing apparatus 1 is capable of performing scheduling on the execution timing of each job such that jobs are executed in descending order of priority.

Here, in the job scheduling described in FIGS. 2 to 4, when many jobs are input at the same time, scheduling is not performed on jobs other than running jobs (hereinafter, also referred to as execution stand-by jobs). Thus, in this case, the worker cannot grasp the turnaround time of the execution stand-by job.

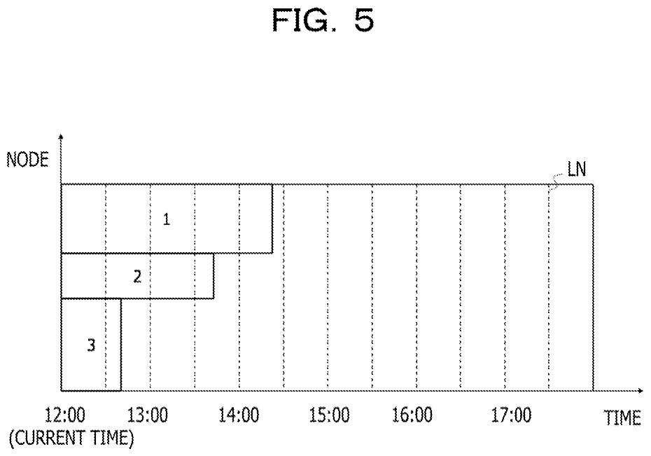

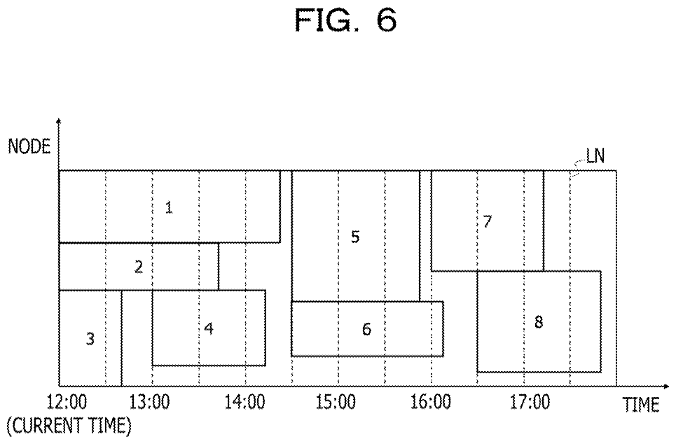

Therefore, for example, as illustrated in FIG. 5, the information processing apparatus 1 divides the time after the current time into predetermined time zones (hereinafter, also referred to as sections). Then, for example, as illustrated in FIG. 6, the information processing apparatus 1 also performs scheduling on the execution stand-by jobs assuming that each job is started from the time corresponding to the cut line LN of each section.

Specifically, for example, as illustrated in FIG. 6, the information processing apparatus 1 performs scheduling such that the execution of the job 4 is started from the cut line LN following the time when the execution of the job 3 is ended (the estimated time of the end of the execution). For example, the information processing apparatus 1 performs scheduling such that the execution of a job with a priority of “5” (hereinafter, also referred to as a job 5) and a job with a priority of “6” (hereinafter, also referred to as a job 6) is started from the cut line LN following the time when the execution of the job 1 and the job 4 is ended.

For example, as illustrated in FIG. 6, the information processing apparatus 1 performs scheduling such that the execution of a job with a priority of “7” (hereinafter, also referred to as a job 7) is started from the cut line LN following the time when the execution of the job 5 is ended. For example, the information processing apparatus 1 performs scheduling such that the execution of a job with a priority of “8” (hereinafter, also referred to as a job 8) is started from the cut line LN following the time when the execution of the job 6 is ended.

Accordingly, the information processing apparatus 1 is capable of performing scheduling on not only a job to be immediately executed or a running job, but also an execution stand-by job. Thus, the information processing apparatus 1 is capable of visualizing the turnaround time of each job. Therefore, the worker is capable of grasping the turnaround time of each job by referring to, for example, the information illustrated in FIG. 6.

Here, the worker may execute, for example, jobs having different execution times in each of time zones. Specifically, for example, the worker repeatedly executes a job having a short execution time within working hours, and executes a job having a long execution time immediately before the end of the working hours. Accordingly, the worker is capable of organizing confirmation timings of job execution results within the working hours as much as possible, and is capable of efficiently performing jobs, including job execution.

However, as described in FIG. 2, etc., the information processing apparatus 1 performs, for example, scheduling on the execution timing of each job according to the priority of each job. Thus, even when a job has a short execution time, the turnaround time may be long.

The estimated turnaround time of each job is calculated at the time when each job is input to the job scheduler. Thus, the worker may not acquire in advance the estimated turnaround time before each job is input.

Thus, the worker may not efficiently perform jobs, including the execution result confirmation of each job. Hereinafter, a specific example when each worker executes jobs will be described.

### Specific Example When Each Worker Executes Jobs

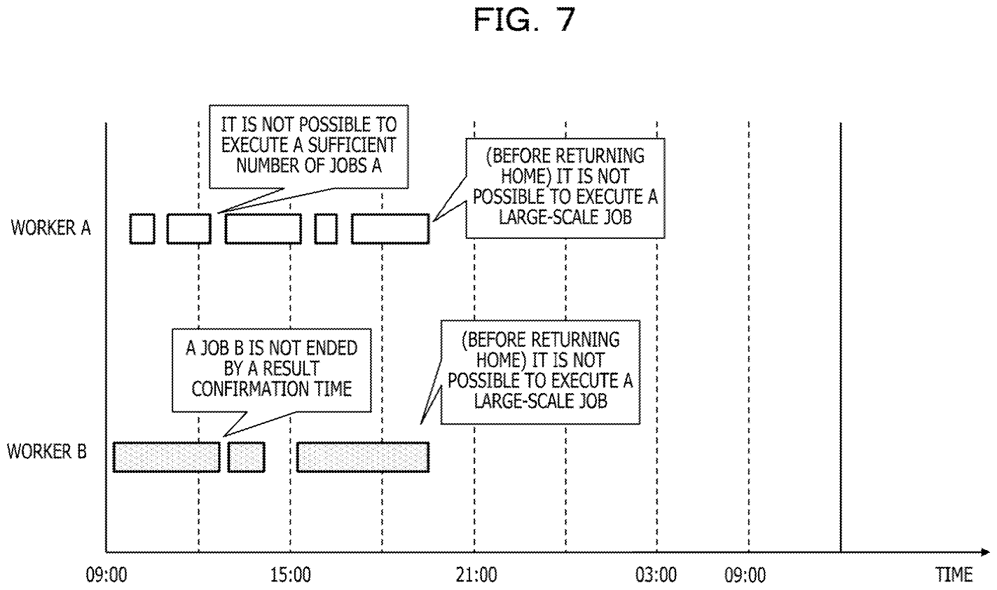

FIG. 7 is a view illustrating a specific example when each worker executes jobs. In the example illustrated in FIG. 7, the horizontal axis indicates a time when each job is executed. In the example illustrated in FIG. 7, the horizontal axis length of a rectangle corresponding to each job corresponds to a turnaround time of each job.

In the example illustrated in FIG. 7, a worker A is a worker who plans to execute a job A having a short execution time (e.g., a job having an execution time of about 1 hour) within working hours, and to execute a large-scale job having a long execution time (for example, a job having an execution time of about 10 hours) outside the working hours. In the example illustrated in FIG. 7, a worker B is a worker who plans to execute a job B having a medium-level execution time (e.g., a job having an execution time of about 2 hours) within the working hours, and to execute a large-scale job outside the working hours.

In the example illustrated in FIG. 7, the white rectangle indicates the job A, and the shaded rectangle indicates the job B. In the example illustrated in FIG. 7, descriptions are made on the assumption that the work end time of the worker A and the worker B (the time of returning home) is 18:00, and the confirmation times of the execution results of the jobs B by the worker B are 12:00, 15:00, and 18:00.

Specifically, in the example illustrated in FIG. 7, turnaround times of some jobs A are longer than turnaround times of other jobs A. In the example illustrated in FIG. 7, turnaround times of some jobs B are longer than turnaround times of other jobs B.

Thus, the example illustrated in FIG. 7 indicates that the worker A may not execute a sufficient number of jobs A within the working hours, and further indicates that the worker A may not execute the large-scale job before the time of returning home because the execution of the lastly executed job A is not ended by the time of returning home.

The example illustrated in FIG. 7 indicates that the worker B may not confirm the execution result of the job B at a predetermined confirmation time (for example, 12:00), and further indicates that the worker B may not execute the large-scale job before the time of returning home because the execution of the lastly executed job B is not ended by the time of returning home.

Therefore, the worker A and the worker B may not efficiently perform jobs, including the execution result confirmation of each job, due to variations, etc., between the jobs in the turnaround time.

Therefore, the information processing apparatus 1 in the embodiment stores a plurality of jobs in a plurality of queues, according to maximum execution times of a plurality of execution target jobs. Then, the information processing apparatus 1 divides the plurality of queues into a plurality of groups, according to the numbers of nodes used when the plurality of jobs is executed.

Subsequently, the information processing apparatus 1 specifies queues (hereinafter, referred to as second queues) other than a queue with a high priority (hereinafter, referred to as a first queue) among the queues included in each group among the groups in each time zone among time zones included in the time when the plurality of jobs is executed. Then, in each of the time zones, the information processing apparatus 1 determines the priority of the second queues to be different priorities lower than the priority of the first queue, for the groups, respectively.

Then, the information processing apparatus 1 determines the execution timings of jobs stored in the queues included in the plurality of groups based on the priorities corresponding to the plurality of groups, in each of the time zones.

That is, before determining the execution order of jobs, the information processing apparatus 1 distributes (stores) the jobs to (in) a plurality of queues according to the maximum execution time and the number of execution nodes of each job. Then, the information processing apparatus 1 performs scheduling on the execution timings of the jobs stored in each queue according to the priorities of each queue determined according to the time zones.

Accordingly, the information processing apparatus 1 is capable of performing scheduling in which the turnaround time of a job may be shortened in a required time zone (for example, a time zone designated by each worker). Specifically, for example, the information processing apparatus 1 is capable of performing scheduling in which the turnaround time of a job may be shortened within working hours of each worker.

### Hardware Configuration of Information Processing System

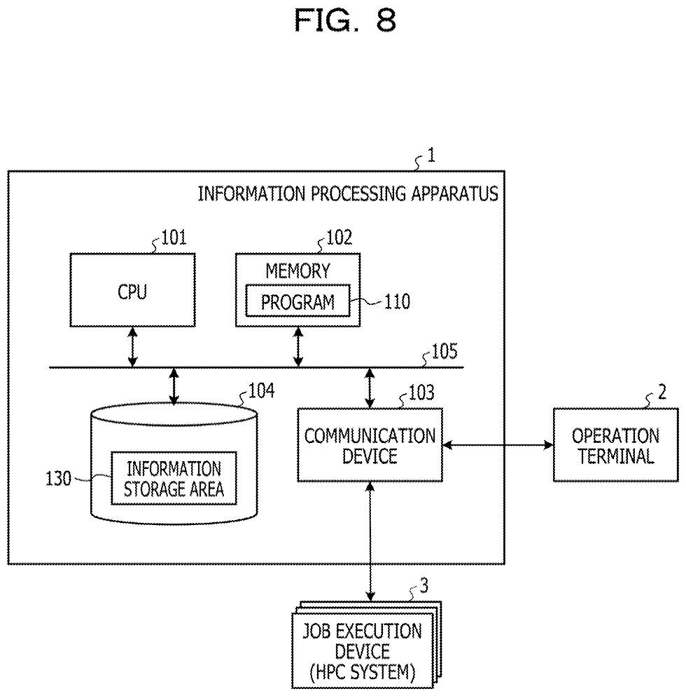

Next, the hardware configuration of the information processing system 10 will be described. FIG. 8 is a view illustrating the hardware configuration of the information processing apparatus 1.

As illustrated in FIG. 8, the information processing apparatus 1 includes a CPU 101 as a processor, a memory 102, a communication device 103, and a storage medium 104. These units are connected to each other via a bus 105.

The storage medium 104 has, for example, a program storage area (not illustrated) that stores a program 110 for performing a process of scheduling execution timings of jobs (hereinafter, also referred to as a job scheduling process). The storage medium 104 has, for example, a storage 130 that stores information used when the job scheduling process is performed (hereinafter, also referred to as an information storage area 130). The storage medium 104 may be, for example, a hard disk drive (HDD) or a solid state drive (SSD).

The CPU 101 performs the job scheduling process by executing the program 110 loaded into the memory 102 from the storage medium 104.

The communication device 103 communicates with the operation terminal 2 and the job execution device 3 via, for example, a network (not illustrated).

### Functions of Information Processing System

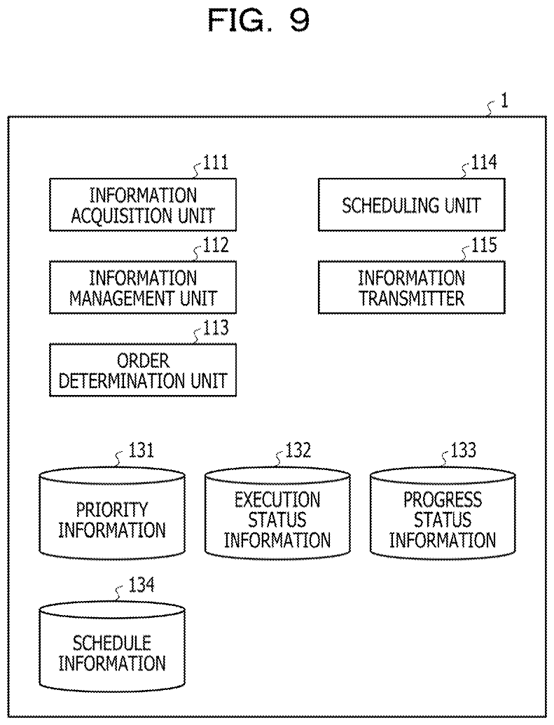

Next, the functions of the information processing system 10 will be described. FIG. 9 is a block diagram of the functions of the information processing apparatus 1.

As illustrated in FIG. 9, in the information processing apparatus 1, for example, hardware such as the CPU 101 or the memory 102 organically collaborates with the program 110 so that various functions including an information acquisition unit 111, an information management unit 112, an order determination unit 113, a scheduling unit 114, and an information transmitter 115 are implemented.

For example, as illustrated in FIG. 9, the information processing apparatus 1 stores priority information 131, execution status information 132, progress status information 133, and schedule information 134, in the information storage area 130.

The information acquisition unit 111 receives, for example, the priority information 131 transmitted from the operation terminal 2.

The information acquisition unit 111 receives, for example, an execution target job transmitted from the operation terminal 2.

The information acquisition unit 111 acquires, for example, the execution status information 132 that indicates a job execution status in each of nodes constituting the job execution device 3, from each node.

The information management unit 112 stores, for example, the priority information 131 received by the information acquisition unit 111, in the information storage area 130.

The information management unit 112 stores, for example, information indicating the job received by the information acquisition unit 111 (hereinafter, also referred to as job information), in any of queues, according to the maximum execution time and the number of execution nodes of the job received by the information acquisition unit 111. Then, the information management unit 112 divides the plurality of queues into a plurality of groups, according to the number of execution nodes of the job corresponding to the information stored in each queue.

The information management unit 112 stores, for example, the execution status information 132 acquired by the information acquisition unit 111, in the information storage area 130.

For each of the groups distributed by the information management unit 112 to time zones included in the time at which a plurality of execution target jobs is executed, the order determination unit 113 specifies second queues which are queues other than a first queue with a high priority in each time zone, among the queues included in each group. Then, in each of the time zones, the order determination unit 113 determines the priority of the second queues to be different priorities lower than the priority of the first queue, for the groups, respectively.

For example, in each of the time zones, the scheduling unit 114 determines execution timings of the jobs stored in the queues included in the plurality of groups, based on the priority that corresponds to each of the groups and is determined by the order determination unit 113, and the execution status information 132 stored in the information storage area 130.

The information transmitter 115 transmits the job received by the information acquisition unit 111 from the operation terminal 2, to the job execution device 3.

The information transmitter 115 transmits the schedule information 134 which is information indicating the execution timing of each job, to the job execution device 3. The progress status information 133 will be described later.

### Outline of First Embodiment

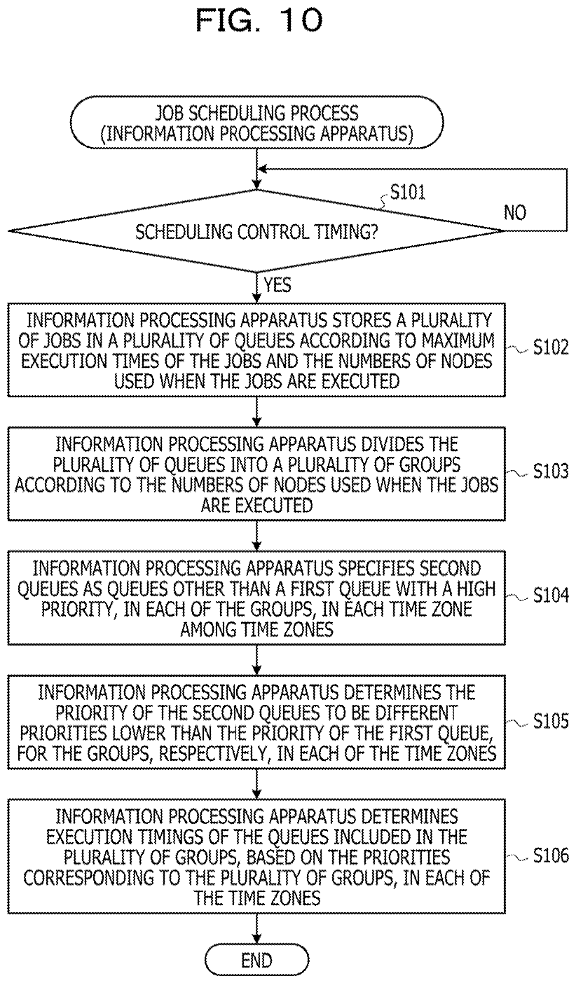

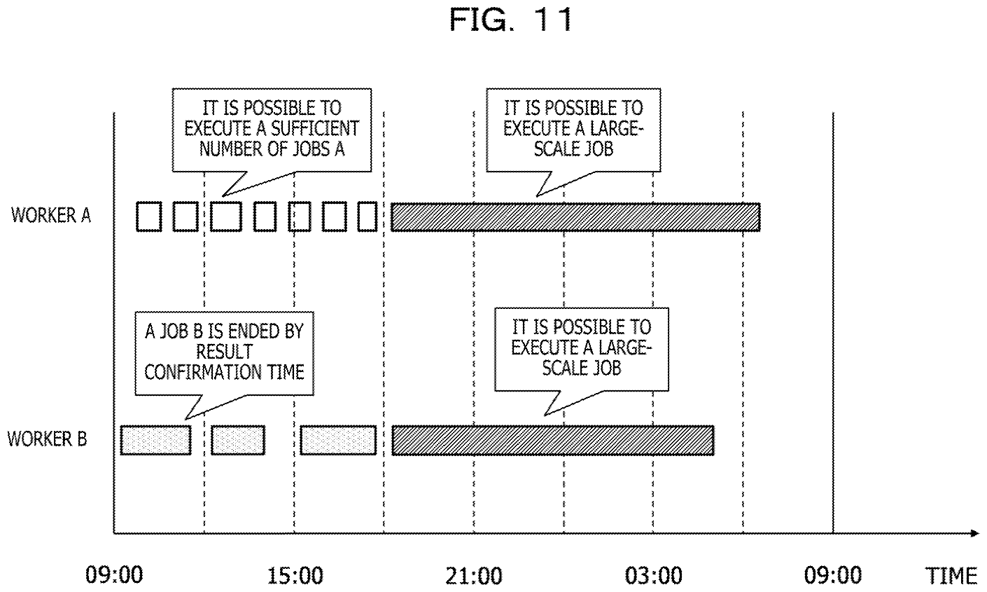

Next, the outline of the first embodiment will be described. FIG. 10 is a flow-chart illustrating the outline of the job scheduling process in the first embodiment. FIG. 11 is a view illustrating the outline of the job scheduling process in the first embodiment.

As illustrated in FIG. 10, the information processing apparatus 1 waits until a scheduling control timing is reached (NO in S101). The scheduling control timing may be, for example, a periodic timing such as every 3 hours.

Then, when the scheduling control timing is reached (YES in S101), the information processing apparatus 1 stores a plurality of execution target jobs in a plurality of queues according to the maximum execution times of the plurality of execution target jobs and the numbers of nodes used when the plurality of execution target jobs is executed (S102).

Subsequently, the information processing apparatus 1 divides the plurality of queues into a plurality of groups according to the numbers of nodes used when the plurality of execution target jobs is executed (S103).

Next, the information processing apparatus 1 specifies second queues which are queues other than a first queue with a high priority, for each of the groups, in each time zone among time zones (S104).

In each of the time zones, the information processing apparatus 1 determines the priority of the second queues to be different priorities lower than the priority of the first queue, for the groups, respectively (S105).

Then, in each of the time zones, the information processing apparatus 1 determines the execution timings of the jobs stored in the queues included in the plurality of groups based on the priorities corresponding to the plurality of groups (S106).

That is, before determining the execution order of jobs, the information processing apparatus 1 distributes (stores) the jobs to (in) a plurality of queues according to the maximum execution time and the number of execution nodes of each job. Then, the information processing apparatus 1 performs scheduling on the execution timings of the jobs stored in each queue according to the priorities of each queue determined according to the time zones.

Accordingly, the information processing apparatus 1 is capable of performing a job scheduling in which the turnaround time of a job may be shortened in a required time zone. Hereinafter, the effect in the first embodiment will be described.

### Effect in First Embodiment

FIG. 11 is a view illustrating the effect in the first embodiment. In the example illustrated in FIG. 11, the diagonally shaded rectangle indicates a large-scale job. Further, hereinafter, only parts different from those in the example described in FIG. 7 will be described.

For example, as illustrated in FIG. 11, the information processing apparatus 1 in the embodiment performs scheduling such that a job having a short execution time (a job A) is executed within working hours of a worker A in preference to a large-scale job. For example, the information processing apparatus 1 performs scheduling such that a job having a medium-level execution time (a job B) is executed within working hours of a worker B in preference to a large-scale job.

Accordingly, the information processing apparatus 1 is capable of suppressing the turnaround times of the job A and the job B within the working hours of the worker A and the worker B. Thus, in this case, for example, the worker A may execute a sufficient number of jobs A within the working hours, and further may start to execute the large-scale job before the time of returning home. In this case, for example, the worker B may confirm the execution result of the job B at a predetermined confirmation time, and further can start to execute the large-scale job before the time of returning home.

### Details of First Embodiment

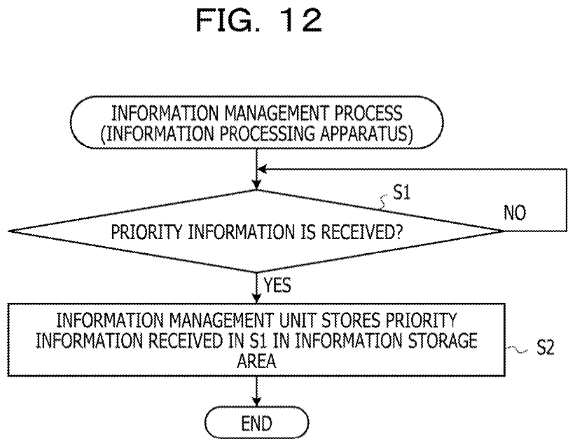

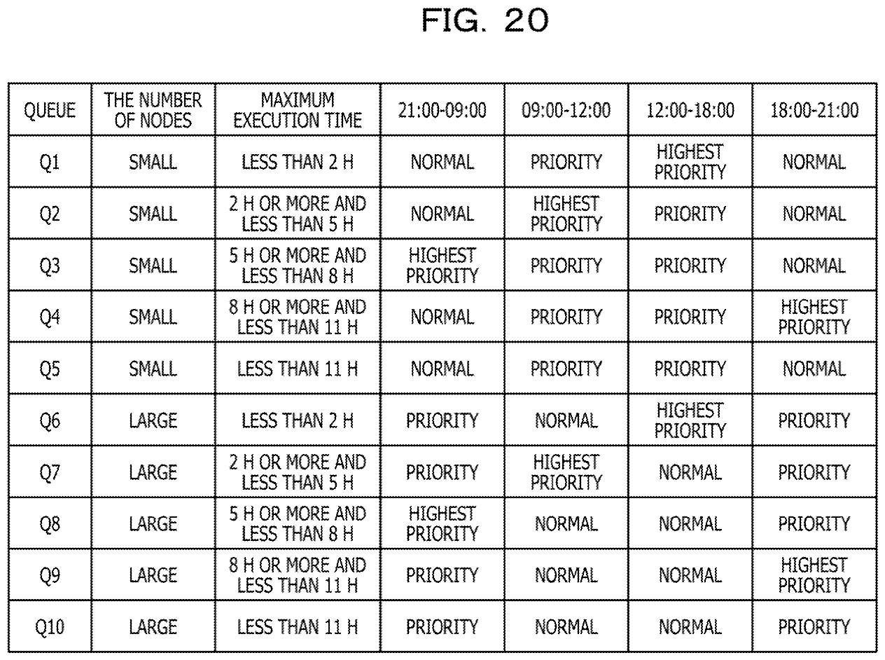

Next, details of the first embodiment will be described. FIGS. 12 to 19 are flowcharts illustrating the details of the job scheduling process in the first embodiment. FIGS. 20 to 28 are views illustrating the details of the job scheduling process in the first embodiment.

### Information Management Process

First, descriptions will be made on a process of managing the priority information 131 (hereinafter, also referred to as an information management process), in the job scheduling process. FIG. 12 is a flowchart illustrating the information management process.

As illustrated in FIG. 12, for example, the information acquisition unit 111 of the information processing apparatus 1 waits until the priority information 131 transmitted from the operation terminal 2 is received (NO in S1).

Then, when the priority information 131 is received (YES in S1), the information management unit 112 of the information processing apparatus 1 stores the received priority information 131 in the information storage area 130 (S2).

The priority information 131 is information indicating the priorities of queues to which jobs are distributed, and is, for example, information determined in advance by a worker. Hereinafter, the specific example of the priority information 131 will be described.

### Specific Example of Priority Information

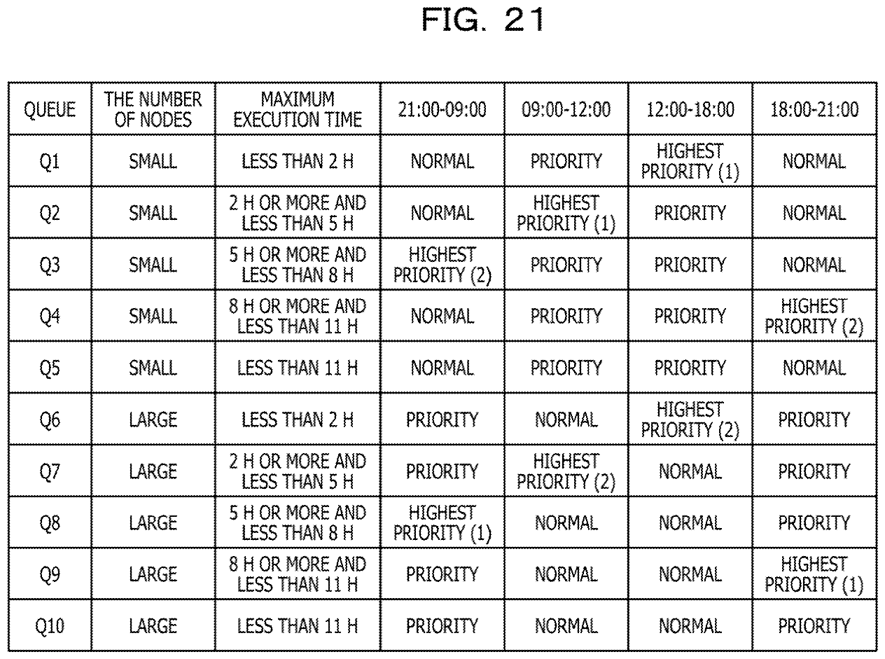

FIGS. 20 and 21 are views illustrating the specific examples of the priority information 131.

The priority information 131 illustrated in FIG. 20, etc., has, as items, “queue” in which identification information of each queue is set, “number of nodes” in which the number of execution nodes of a job stored in each queue is set, and “maximum execution time” in which the maximum execution time of a job stored in each queue is set.

The priority information 131 illustrated in FIG. 20, etc. has, as items, “21:00-09:00” in which the priority of each queue between 21:00 and 09:00 is set, and “09:00-12:00” in which the priority of each queue between 09:00 and 12:00 is set. Further, the priority information 131 illustrated in FIG. 20, etc. has, as items, “12:00-18:00” in which the priority of each queue between 12:00 and 18:00 is set, and “18:00-21:00” in which the priority of each queue between 18:00 and 21:00 is set.

In the “21:00-09:00,” the “09:00-12:00,” the “12:00-18:00” and the “18:00-21:00” in the priority information 131 illustrated in FIG. 20, for example, “highest priority” corresponding to a group of queues with the highest priority (hereinafter, also referred to as most prioritized queues) is set. In the “21:00-09:00,” etc., in the priority information 131 illustrated in FIG. 20, for example, “priority” corresponding to a group of queues with the second highest priority after the most prioritized queues (hereinafter, also referred to as prioritized queues) is set. In the “21:00-09:00,” etc., in the priority information 131 illustrated in FIG. 20, for example, “normal” corresponding to a group of queues with a low priority (hereinafter, also referred to as normal queues) is set. Further, in the “node” in the priority information 131 illustrated in FIG. 20, for example, either “small” corresponding to the number of nodes less than 1/4 of all nodes or “large” corresponding to the number of 1/4 or more nodes of all nodes is set.

Specifically, in the priority information 131 illustrated in FIG. 20, in the information (information in the 1^{st} row) in which “Q1” is set in the “queue,” “small” is set as the “number of nodes,” “less than 2 h” is set as the “execution time,” and “normal” is set as the “21:00-09:00.” In the information (information in the 1^{st} row) in which “Q1” is set in the “queue,” “priority” is set as the “09:00-12:00,” “highest priority” is set as the “12:00-18:00,” and “normal” is set as the “18:00-21:00.”

In the priority information 131 illustrated in FIG. 20, in the information (information in the 2^{nd} row) in which “Q2” is set in the “queue,” “small” is set as the “number of nodes,” “2 hours or more, less than 5 hours” is set as the “execution time,” and “normal” is set as the “21:00-09:00.” In the information (information in the 2^{nd} row) in which “Q2” is set in the “queue,” “highest priority” is set as the “09:00-12:00,” “priority” is set as the “12:00-18:00,” and “normal” is set as the “18:00-21:00.” Descriptions on the other information included in FIG. 20 will be omitted.

Here, in the priority information 131 illustrated in FIG. 20, setting is made such that in the time zone between 09:00 and 18:00, priorities of queues (queues Q1, Q2, Q6, and Q7) whose maximum execution times are less than 5 hours are high.

Accordingly, the information processing apparatus 1 performs distribution of jobs based on the priority information 131 illustrated in FIG. 20, so that jobs having relatively short maximum execution times may be organized and executed within working hours of each worker. Thus, the information processing apparatus 1 is capable of performing a control such that the turnaround time of the job having a relatively short maximum execution time is shortened within the working hours of each worker.

In the priority information 131 illustrated in FIG. 20, setting is made such that in the time zone between 18:00 and 09:00, priorities of queues (queues Q3, Q4, Q8, and Q9) whose maximum execution times are 5 hours or more and less than 11 hours are high.

Accordingly, the information processing apparatus 1 performs distribution of jobs based on the priority information 131 illustrated in FIG. 20, and thus is capable of performing a control such that large-scale jobs are executed outside the working hours of each worker.

Meanwhile, queues (queues Q5 and Q10) whose maximum execution times are 11 hours or more are queues in which jobs requiring relatively long execution times are stored, and are queues in which the influence on the work efficiency of the worker is not significantly changed regardless of a time zone during which the jobs are executed. Thus, in the priority information 131 illustrated in FIG. 20, a time zone during which the queues whose maximum execution times are 11 hours or more become most prioritized queues is not set.

As illustrated in FIG. 21, the worker may set a different priority for each queue included in the most prioritized queues.

Specifically, for example, as illustrated in FIG. 21, the worker may set “highest priority (1)” indicating a queue with the highest priority, as information corresponding to a queue with the highest priority among queues included in the most prioritized queues. For example, the worker may set “highest priority (2)” indicating a queue with the second highest priority, as information corresponding to a queue with the second highest priority among queues included in the most prioritized queues.

### Job Management Process

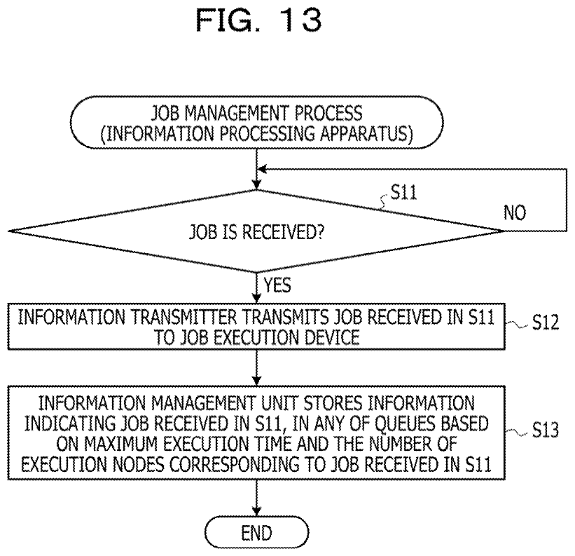

Next, descriptions will be made on a process of managing jobs (hereinafter, also referred to as a job management process), in the job scheduling process. FIG. 13 is a flowchart illustrating the job management process.

For example, as illustrated in FIG. 13, the information acquisition unit 111 waits until a job (execution target job) transmitted from the operation terminal 2 is received (NO in S11). Specifically, for example, the information acquisition unit 111 waits until the execution target job is received together with information including a maximum execution time and the number of execution nodes.

Then, when the job is received (YES in S11), the information transmitter 115 of the information processing apparatus 1 transmits the job received through the processing in S11, to the job execution device 3 (S12).

In this case, the information management unit 112 stores information indicating the job received through the processing in S11, in any of queues based on the maximum execution time and the number of execution nodes corresponding to the job received through the processing in S11 (S13).

Specifically, for example, the information management unit 112 stores information indicating the job received through the processing in S11, in any of queues by referring to the maximum execution time and the number of execution nodes included in the information that is received together with the job in the processing in S11. Hereinafter, a specific example of the processing in S13 will be described.

### Specific Example of Processing in S13

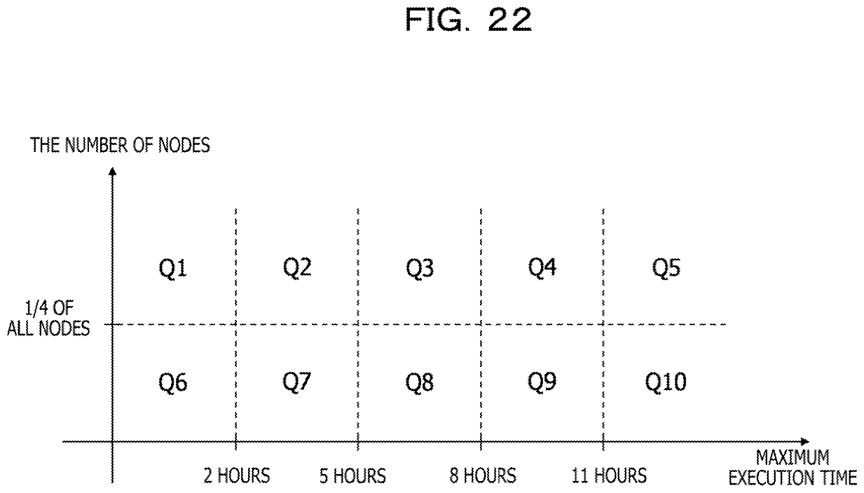

FIGS. 22 to 24 are views illustrating the specific example of the processing in S13. The horizontal axis and the vertical axis in the example illustrated in FIG. 22 indicate the maximum execution time of each job and the number of execution nodes of each job, respectively.

Specifically, for example, the example illustrated in FIG. 22 indicates that a job whose maximum execution time is less than 2 hours and whose number of execution nodes is 1/4 or more of the total number of nodes is distributed to the queue Q1. For example, the example illustrated in FIG. 22 indicates that a job whose maximum execution time is 2 hours or more and less than 5 hours and whose number of execution nodes is 1/4 or more of the total number of nodes is distributed to the queue Q2. Further, for example, the example illustrated in FIG. 22 indicates that a job whose maximum execution time is 5 hours or more and less than 8 hours and whose number of execution nodes is 1/4 or more of the total number of nodes is distributed to the queue Q3.

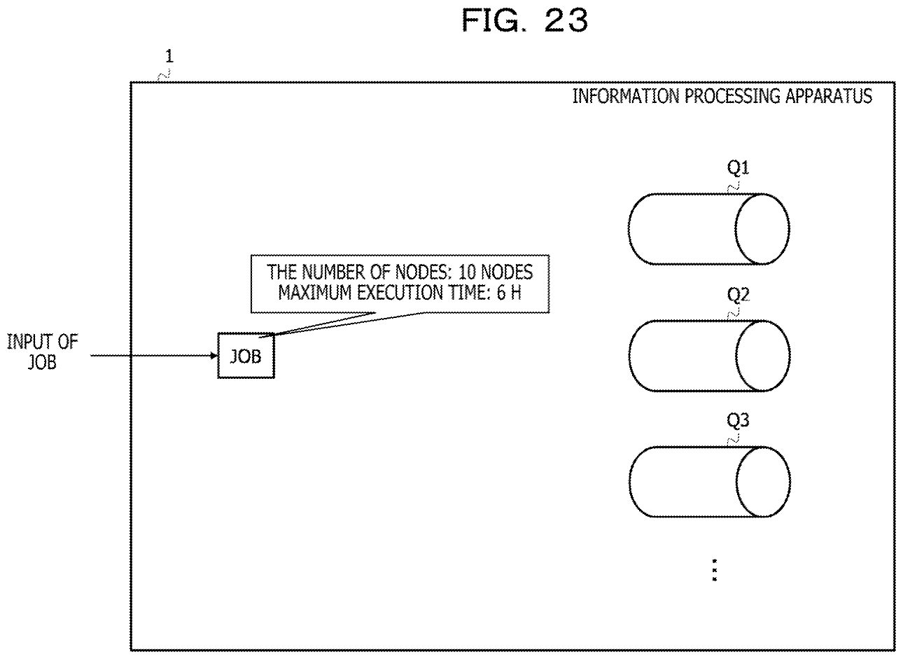

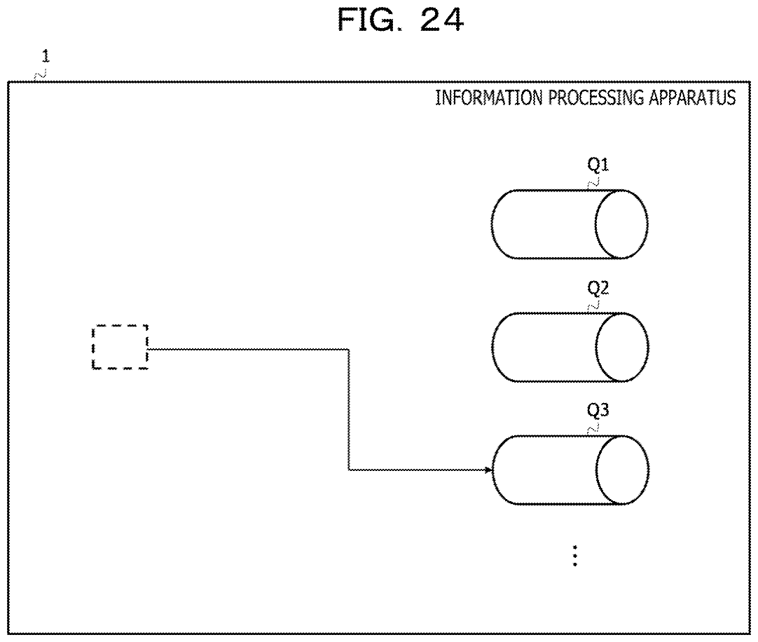

Therefore, for example, in a case where the number of nodes of the job execution device 3 is 32, when a new job whose maximum execution time is 6 hours and whose number of execution nodes is 10 is input, as illustrated in FIGS. 23 and 24, the information processing apparatus 1 stores the new job in the queue Q3. Descriptions on the other information included in FIG. 22 will be omitted.

Hereinafter, 2 hours, 5 hours, 8 hours, and 11 hours in the maximum execution time illustrated in FIG. 22 are also referred to as second threshold values, and 1/4 of the total number of nodes in the number of execution nodes is also referred to as a third threshold value.

### Order Determination Process

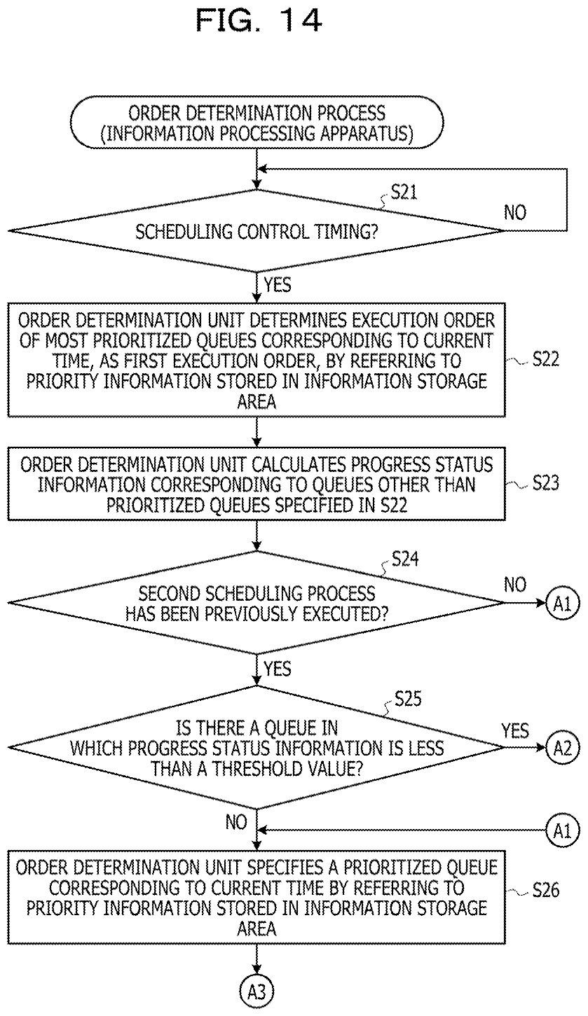

Next, descriptions will be made on a process of determining the execution order of jobs stored in queues (hereinafter, also referred to as an order determination process), in the job scheduling process. FIGS. 14 to 16 are flowcharts illustrating the order determination process.

As illustrated in FIG. 14, for example, the order determination unit 113 of the information processing apparatus 1 waits until a schedule control timing is reached (NO in S21).

Then, when the schedule control timing is reached (YES in S21), the order determination unit 113 determines the execution order of the most prioritized queues corresponding to a current time, as the first execution order, by referring to the priority information 131 stored in the information storage area 130 (S22).

Specifically, in the priority information 131 described in FIG. 21, “highest priority (1)” is set in the “09:00-12:00” of information in which the “queue” is “Q2,” and “highest priority (2)” is set in the “09:00-12:00” of information in which the “queue” is “Q7.” Thus, for example, when the current time is 09:00, the order determination unit 113 specifies the queues Q2 and Q7 as the most prioritized queues corresponding to the current time.

Then, in this case, the order determination unit 113 determines the execution order of a job included in the queue Q2 with the “highest priority (1)” during “09:00-12:00,” as the first, and determines the execution order of a job included in the queue Q7 with the “highest priority (2)” during “09:00-12:00,” as the second.

When there is a plurality of jobs stored in the queue Q2, for example, the order determination unit 113 may determine the execution order of the jobs stored in the queue Q2 in the order in which the jobs are stored in the queue Q2. Likewise, when there is a plurality of jobs stored in the queue Q7, for example, the order determination unit 113 may determine the execution order of the jobs stored in the queue Q7 in the order in which the jobs are stored in the queue Q7.

Subsequently, for example, the order determination unit 113 calculates the progress status information 133 corresponding to queues other than the prioritized queues specified in the processing in S22 (S23). The progress status information 133 is information indicating the progress statuses of execution of jobs stored in queues (progress rates of job execution). Hereinafter, descriptions will be made on a specific example of the progress status information 133.

### Specific Example of Progress Status Information

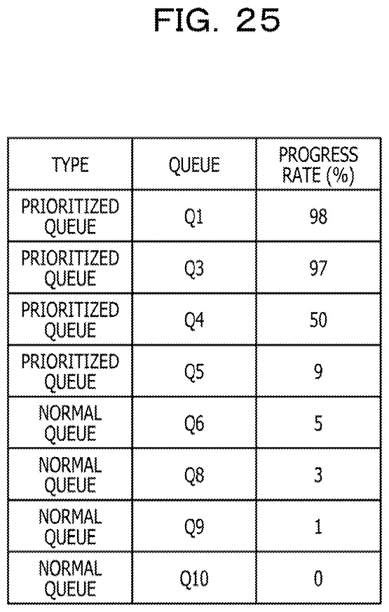

FIG. 25 is a view illustrating the specific example of the progress status information 133. The progress status information 133 illustrated in FIG. 25 has, as items, “Type” in which the type of each queue is set, “Queue” in which identification information of each queue is set, and “Progress Rate” in which the progress status (progress rate) of execution of jobs included in each queue is set.

Specifically, for example, when a value obtained by dividing the number of jobs executed during previous three hours among jobs stored in the queue Q1 as a prioritized queue, by the number of jobs stored in the queue Q1 during the previous three hours, is “0.98,” as illustrated in the 1^{st} row in FIG. 25, the order determination unit 113 sets “prioritized queue” as the “Type,” sets “Q1” as the “Queue,” and sets “98 (%)” as the “Progress Rate.”

For example, when a value obtained by dividing the number of jobs executed during previous three hours among jobs stored in the queue Q3 as a prioritized queue, by the number of jobs stored in Q3 during the previous three hours, is “0.97,” as illustrated in the 2^{nd} row in FIG. 25, the order determination unit 113 sets “prioritized queue” as the “Type,” sets “Q3” as the “Queue,” and sets “97 (%)” as the “Progress Rate.”

For example, when a value obtained by dividing the number of jobs executed during previous three hours among jobs stored in the queue Q6 as a normal queue, by the number of jobs stored in the queue Q6 during the previous three hours, is “0.05,” as illustrated in the 5th row in FIG. 25, the order determination unit 113 sets “normal queue” as the “Type,” sets “Q6” as the “Queue,” and sets “5(%)” as the “Progress Rate.” Descriptions on the other information included in FIG. 25 will be omitted.

Referring back to FIG. 14, the order determination unit 113 determines whether a second scheduling process has been carried out in the order determination process that has been previously performed (previous-time order determination process) (S24).

As a result, when it is determined that the second scheduling process has been carried out in the order determination process that has been previously performed (YES in S24), the order determination unit 113 determines whether there is a queue in which the progress status information 133 calculated in the processing in S23 is less than a predetermined threshold value (hereinafter, also referred to as a fourth threshold value) (S25).

Specifically, in this case, for example, the order determination unit 113 determines whether there is a queue in which the progress rate calculated in the processing in S23 is less than 50(%).

Then, when it is determined that there is no queue in which the progress status information 133 calculated in the processing in S23 is less than the predetermined threshold value (NO in S25), the order determination unit 113 specifies a prioritized queue corresponding to the current time by referring to the priority information 131 stored in the information storage area 130 (S26).

Specifically, in the priority information 131 described in FIG. 21, “priority” is set in the “09:00-12:00” in information with the “queue” of “Q1,” “Q3,” “Q4,” and “Q5.” Thus, for example, when the current time is 09:00, the order determination unit 113 specifies the queues Q1, Q3, Q4, and Q5 as prioritized queues corresponding to the current time.

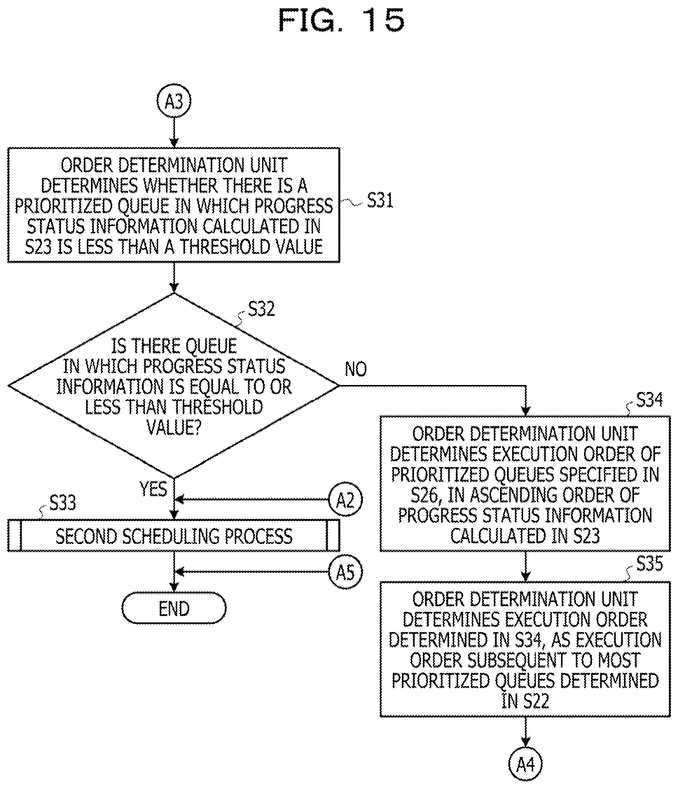

Next, as illustrated in FIG. 15, the order determination unit 113 determines whether there is a prioritized queue in which the progress status information 133 calculated in the processing in S23 is less than a predetermined threshold value (hereinafter, also referred to as a first threshold value) (S31).

Specifically, for example, the order determination unit 113 determines whether there is a prioritized queue in which the progress rate calculated in the processing in S23 is less than 90(%).

As a result, when it is determined that there is a prioritized queue in which the progress status information 133 calculated in the processing in S23 is less than the predetermined threshold value (YES in S32), the scheduling unit 114 of the information processing apparatus 1 executes a second scheduling process to be described later (S33).

That is, in this case, the scheduling unit 114 determines that the jobs having information pieces stored in the queues are not equally executed. Thus, in this case, the scheduling unit 114 executes the second scheduling process so that the jobs having information pieces stored in the queues are equally executed.

Specifically, in the progress status information 133 described in FIG. 25, “50(%)” is set as the “progress rate” in information (information in the 3^{rd} row) in which “Q4” is set as the “queue,” and “9(%)” is set as the “progress rate” in information (information in the 4^{th} row) in which “Q5” is set as the “queue.” Thus, for example, when the predetermined threshold value in the processing in S31 is 90(%), the order determination unit 113 determines that there are prioritized queues (the queues Q4 and Q5) in which the progress status information 133 is less than the predetermined threshold value. Therefore, in this case, the scheduling unit 114 executes the second scheduling process.

Also, when it is determined that there is a queue in which the progress status information 133 calculated in the processing in S23 is less than the predetermined threshold value (YES in S25), the scheduling unit 114 similarly executes the second scheduling process (S33).

That is, in this case, even though the second scheduling process has already been performed, the scheduling unit 114 determines that the jobs having information pieces stored in the queues are not equally executed.

Thus, in this case, the scheduling unit 114 further executes the second scheduling process so that the jobs having information pieces stored in the queues are equally executed.

Meanwhile, when it is determined that there is no prioritized queue in which the progress status information 133 calculated in the processing in S23 is less than the predetermined threshold value (NO in S32), the order determination unit 113 determines the execution order of the prioritized queues specified in the processing in S26, in an ascending order of the values corresponding to the progress status information 133 calculated in the processing in S23 (S34).

Specifically, in the progress status information 133 described in FIG. 25, “98(%),” “97(%),” “50(%),” and “9(%)” are set as the “Progress Rate” in information pieces, respectively, in which “Q1,” “Q3,” “Q4,” and “Q5” are set as the “Queue.” Thus, for example, the order determination unit 113 determines to execute the queue Q5, the queue Q4, the queue Q3, and the queue Q1 in this order by referring to the progress status information 133 described in FIG. 25.

Then, the order determination unit 113 determines the execution order determined in the processing in S34, as an execution order subsequent to the most prioritized queues determined in the processing in S22 (S35).

Specifically, when the execution order of the queue Q2 and the queue Q7 is determined in the processing in S22, and the execution order of the queue Q5, the queue Q4, the queue Q3, and queue Q1 is determined in the processing in S34, the order determination unit 113 determines to execute the queue Q2, the queue Q7, the queue Q5, the queue Q4, the queue Q3, and the queue Q1 in this order.

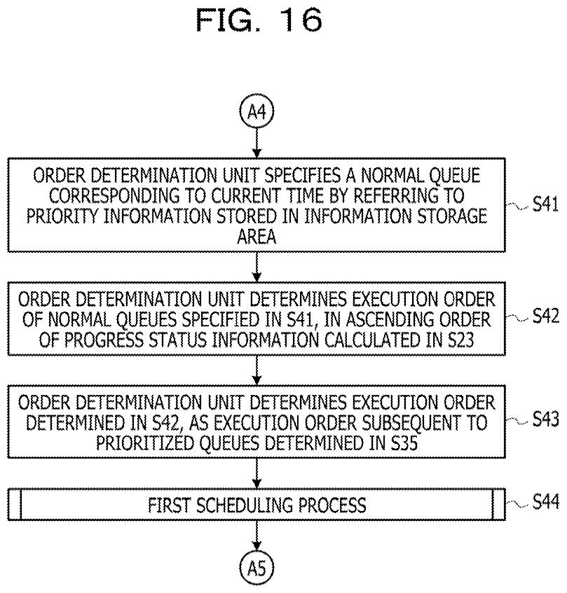

Subsequently, as illustrated in FIG. 16, the order determination unit 113 specifies a normal queue corresponding to the current time by referring to the priority information 131 stored in the information storage area 130 (S41).

Then, the order determination unit 113 determines the execution order of the normal queues specified in the processing in S41, in an ascending order of the values calculated in the processing in S23 (S42).

Specifically, in the progress status information 133 described in FIG. 25, “5(%),” “3(%),” “1(%),” and “0(%)” are set as the “Progress Rate” in information pieces, respectively, in which “Q6,” “Q8,” “Q9,” and “Q10” are set as the “Queue.” Thus, for example, the order determination unit 113 determines to execute the queue Q10, the queue Q9, the queue Q8, and the queue Q6 in this order by referring to the progress status information 133 described in FIG. 25.

Then, the order determination unit 113 determines the execution order determined in the processing in S42, as an execution order subsequent to the prioritized queues determined in the processing in S35 (S43).

Specifically, the order determination unit 113 determines to execute, for example, the queue Q2, the queue Q7, the queue Q5, the queue Q4, the queue Q3, the queue Q1, the queue Q10, the queue Q9, the queue Q8, and the queue Q6 in this order.

Then, the order determination unit 113 and the scheduling unit 114 execute a first scheduling process to be described below (S45).

### First Scheduling Process

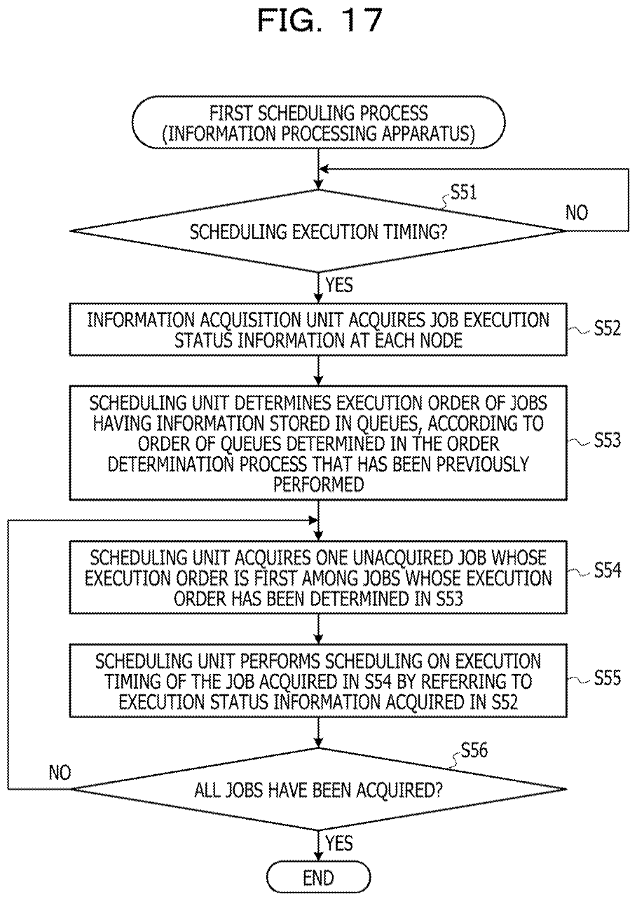

Next, descriptions will be made on the first scheduling process in the job scheduling process. The first scheduling process is a scheduling process that is performed when in the processing in S32, it is determined that there is no prioritized queue in which the progress status information 133 is less than the predetermined threshold value. That is, the first scheduling process is a scheduling process that is performed when it can be determined that the jobs corresponding to information pieces stored in the queues are executed equally to some extent. FIG. 17 is a flowchart illustrating the first scheduling process.

As illustrated in FIG. 17, the information acquisition unit 111 of the information processing apparatus 1 waits until a scheduling execution timing is reached (NO in S51). Here, for example, the scheduling execution timing may be a time when it is determined that there is no prioritized queue in which the progress status information 133 is less than the predetermined threshold value in the processing in S32. Here, for example, when it is determined that there is no prioritized queue in which the progress status information 133 is less than the predetermined threshold value in the processing in S32 (the processing in S32 which has been previously performed), the scheduling execution timing may be a time when the job execution is started or a time when the job execution is ended in the job execution device 3.

Then, when the scheduling execution timing is reached (YES in S51), the information acquisition unit 111 acquires the execution status information 132 on the jobs at nodes (S52). Hereinafter, a specific example of the execution status information 132 on the jobs will be described.

### Specific Example of Execution Status Information

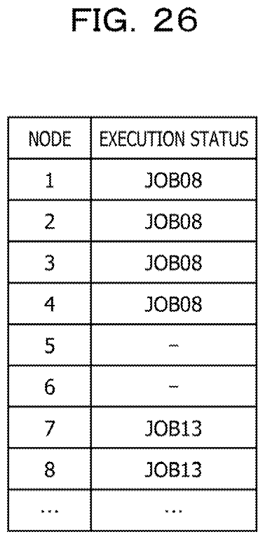

FIG. 26 is a view illustrating the specific example of the execution status information 132.

The execution status information 132 illustrated in FIG. 26 has, as items, “Node” in which identification information of each node is set, and “Execution Status” in which identification information of a job running at each node is set.

Specifically, in the execution status information 132 illustrated in FIG. 26, for example, in the information in the 1^{st} row, “1” is set as the “Node,” and “JOB08” is set as the “Execution Status.” In the execution status information 132 illustrated in FIG. 26, for example, in the information in the 2^{nd} row, “2” is set as the “Node,” and “JOB08” is set as the “Execution Status.”

That is, the execution status information 132 illustrated in FIG. 26 indicates that JOB08 is executed over a plurality of nodes. Descriptions on the other information included in FIG. 26 will be omitted.

Referring back to FIG. 17, the scheduling unit 114 determines the execution order of the jobs having information pieces stored in the queues, according to the order of the queues determined in the order determination process that has been previously performed (S53).

Specifically, for example, the scheduling unit 114 determines to execute a job having information stored in the queue Q2, a job having information stored in the queue Q7, and a job having information stored in the queue Q5 in this order, according to the order of the queues determined in the order determination process that has been previously performed.

When a plurality of jobs is stored in the same queue, for example, the scheduling unit 114 may determine the execution order of the jobs, according to the order in which the jobs are input. When there is a plurality of queues having the same order, for example, the scheduling unit 114 may determine the execution order of the jobs included in the plurality of queues, according to the order in which the jobs are input.

Then, the scheduling unit 114 acquires one unacquired job whose execution order is first among the jobs whose execution order has been determined in the processing in S53 (S54).

Subsequently, the scheduling unit 114 performs scheduling on the execution timing of the job acquired in the processing in S54 by referring to the execution status information 132 acquired in the processing in S52 (S55).

Specifically, for example, the scheduling unit 114 determines that JOB08 is executed at the plurality of nodes including the node with identification information of “1” by referring to the execution status information 132 described in FIG. 26. Further, for example, the scheduling unit 114 determines that JOB13 is executed at the plurality of nodes including the node with identification information of “7” by referring to the execution status information 132 described in FIG. 26.

Then, the scheduling unit 114 calculates an estimated time required until the execution of each job is ended, by referring to the maximum execution time of each of running jobs, including JOB08 and JOB13. Further, from the estimated time required until the execution of each job is ended, the scheduling unit 114 specifies an estimated time during which an unexecuted job is schedulable (hereinafter, also referred to as schedulable time) at each node. Then, for example, in the same manner as in the case described in FIGS. 5 and 6, the scheduling unit 114 performs scheduling of the job acquired in the processing in S54, in a time during which the job acquired in the processing in S54 is executable, in a schedulable time.

Next, the scheduling unit 114 determines whether all jobs have been acquired in the processing in S54 (S56).

As a result, when it is determined that not all jobs have been acquired in the processing in S54 (NO in S56), the scheduling unit 114 performs S54 and the subsequent process again.

Meanwhile, when it is determined that all jobs have been acquired in the processing in S54 (YES in S56), the scheduling unit 114 ends the first scheduling process.

When it is determined that all jobs have been acquired in the processing in S54 (YES in S56), the scheduling unit 114 may generate the schedule information 134 indicating the result of scheduling performed in the processing in S55. Then, in this case, the information transmitter 115 may transmit the schedule information 134 generated by the scheduling unit 114, to the job execution device 3.

Accordingly, the job execution device 3 is capable of executing jobs according to the job scheduling performed by the scheduling unit 114. Hereinafter, a specific example of the schedule information 134 will be described.

### Specific Example of Schedule Information

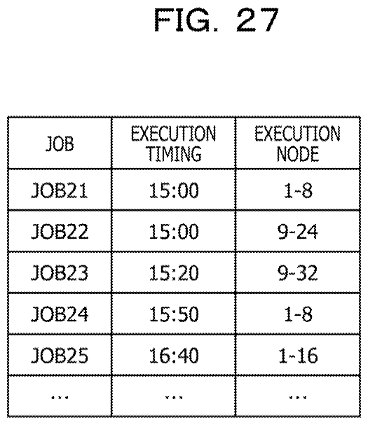

FIG. 27 is a view illustrating the specific example of the schedule information 134.

The schedule information 134 illustrated in FIG. 27 has, as items, “Job” in which identification information of each job is set, “Execution Timing” in which the execution timing of each job is set, and “Execution Node” in which identification information of the execution node of each job is set.

Specifically, in the schedule information 134 illustrated in FIG. 27, in the information with the “Job” of “JOB21” (information in the 1^{st} row), “15:00” is set as the “Execution Timing,” and “1-8” is set as the “Execution Node.”

In the schedule information 134 illustrated in FIG. 27, in the information with the “Job” of “J0B22” (information in the 2nd row), “15:00” is set as the “Execution Timing,” and “9-24” is set as the “Execution Node.” Descriptions on the other information included in FIG. 27 will be omitted.

### Second Scheduling Process

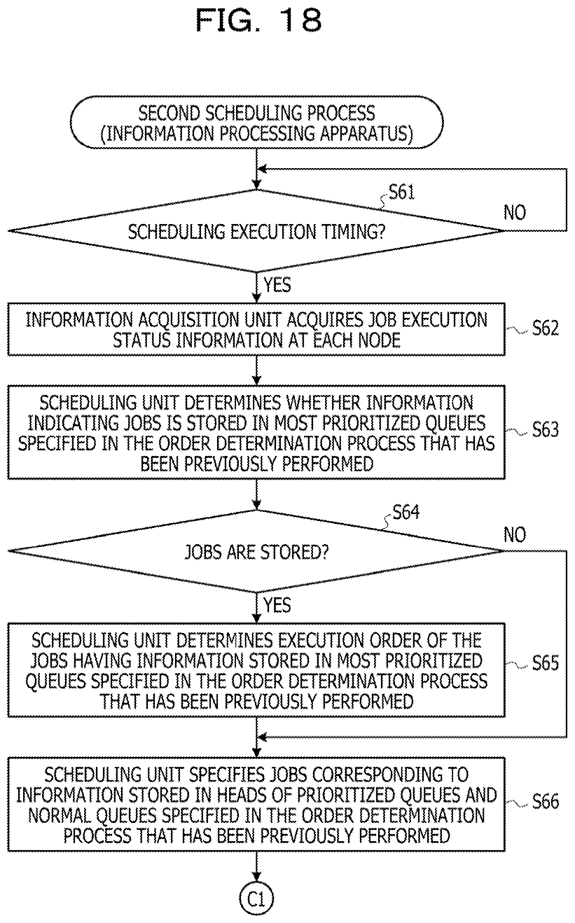

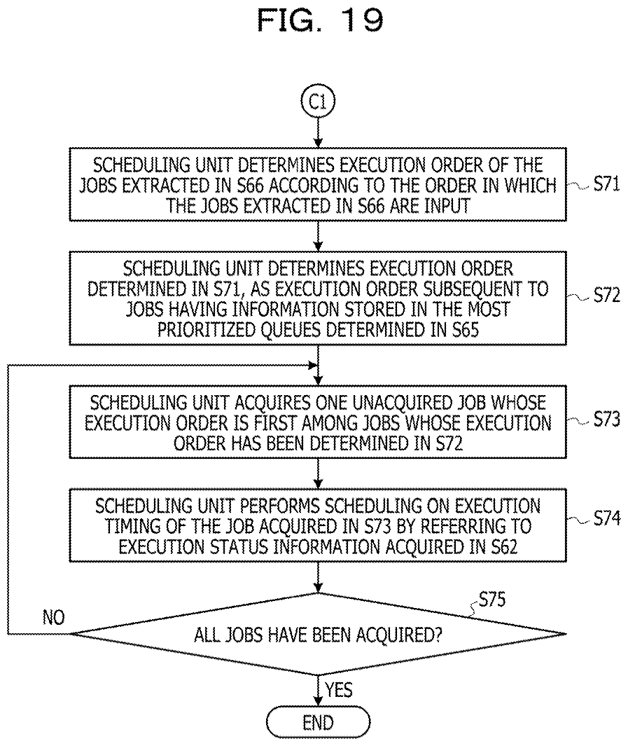

Next, descriptions will be made on the second scheduling process in the job scheduling process. The second scheduling process is a scheduling process that is performed when in the processing in S32, it is determined that there is a prioritized queue in which the progress status information 133 is less than the predetermined threshold value. That is, the second scheduling process is a scheduling process that is performed when it can be determined that the jobs corresponding to information pieces stored in the queues are not equally executed. FIGS. 18 and 19 are flowcharts illustrating the second scheduling process.

As illustrated in FIG. 18, the information acquisition unit 111 waits until a scheduling execution timing is reached (NO in S61). Here, for example, the scheduling execution timing may be a time when it is determined that there is a prioritized queue in which the progress status information 133 is less than the predetermined threshold value in the processing in S32. Here, for example, when it is determined that there is a prioritized queue in which the progress status information 133 is less than the predetermined threshold value in the processing in S32 (the processing in S32 which has been previously performed), the scheduling execution timing may be a time when the job execution is started or a time when the job execution is ended in the job execution device 3.

Then, when the scheduling execution timing is reached (YES in S61), the information acquisition unit 111 acquires the execution status information 132 on the jobs at nodes (S62).

Subsequently, the scheduling unit 114 determines whether jobs are stored in the most prioritized queues specified in the order determination process that has been previously performed (S63).

Specifically, in the priority information 131 described in FIG. 21, “highest priority (1)” is set in the “09:00-12:00” in information with the “Queue” of “Q2,” and “highest priority (2)” is set in the “09:00-12:00” in information with the “Queue” of “Q7.” Thus, for example, when the current time is 09:00, the order determination unit 113 determines whether jobs are stored in the queue Q2 and the queue Q7.

Then, when it is determined that jobs are stored in the most prioritized queues specified in the order determination process that has been previously performed (YES in S64), the scheduling unit 114 determines the execution order of the jobs stored in the most prioritized queues specified in the order determination process that has been previously performed (S65).

Specifically, for example, the scheduling unit 114 determines to execute the job stored in the queue Q2 and the job stored in the queue Q7 in this order, according to the order of the queues determined in the order determination process that has been previously performed.

Meanwhile, when it is determined that jobs are not stored in the most prioritized queues specified in the order determination process that has been previously performed (NO in S64), the scheduling unit 114 does not execute the processing in S65.

Next, the scheduling unit 114 specifies a job corresponding to information stored in the head of each of the prioritized queues and the normal queues specified in the order determination process that has been previously performed (S66).

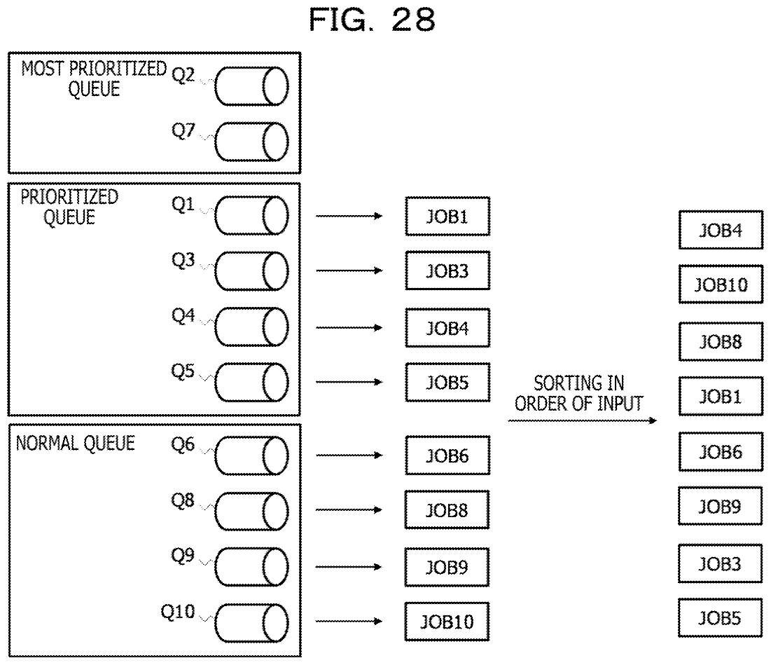

Specifically, for example, the progress status information 133 described in FIG. 25 indicates that the queue Q1, the queue Q3, the queue Q4, and the queue Q5 are prioritized queues, and the queue Q6, the queue Q8, the queue Q9, and the queue Q10 are normal queues. Thus, in this case, as illustrated in FIG. 28, the scheduling unit 114 specifies jobs (JOB1, JOB3, JOB4, JOBS, JOB6, JOBS, JOB9, and JOB10) corresponding to information pieces stored in heads of the queue Q1, the queue Q3, the queue Q4, the queue Q5, the queue Q6, the queue Q8, the queue Q9, and the queue Q10, respectively.

In the processing in S66, the scheduling unit 114 may specify information corresponding to a predetermined number (two or more) of information pieces from the head of each of the prioritized queues and the normal queues specified in the order determination process that has been previously performed.

Then, as illustrated in FIG. 19, the scheduling unit 114 determines the execution order of the jobs extracted in the processing in S66, according to the order in which the jobs specified in the processing in S66 are input (S71).

Specifically, as illustrated in FIG. 28, the scheduling unit 114 sorts the jobs specified in the processing in S66, for example, in the order of JOB4, JOB10, JOBS, JOB1, JOB6, JOB9, JOB3, and JOBS.

Subsequently, the scheduling unit 114 determines the execution order determined in the processing in S71, as the execution order subsequent to the jobs having information stored in the most prioritized queues determined in the processing in S65 (S72).

That is, when in the processing in S32, there is a prioritized queue in which the progress rate of job execution is equal to or less than the predetermined threshold value, the order determination unit 113 determines that there is a high possibility that a job that has not been executed for a long time is included in the normal queue. Then, in this case, the order determination unit 113 executes the second scheduling process in which scheduling is performed assuming that there is no difference in the priority between the job stored in the prioritized queue and the job stored in the normal queue.

Meanwhile, when it is determined that there is no high possibility that a job that has not been executed for a long time is included in the normal queue, the scheduling unit 114 executes the first scheduling process in which job scheduling is performed according to the priority of each queue, as usual.

Accordingly, the information processing apparatus 1 is capable of performing a job scheduling in which the turnaround time of a job may be shortened in a required time zone, and a job that has not been executed for a relatively long time may be prevented from occurring.

Referring back to FIG. 19, the scheduling unit 114 acquires one unacquired job whose execution order is first among the jobs whose execution order has been determined in the processing in S72 (S73).

Subsequently, the scheduling unit 114 performs scheduling on the execution timing of the job acquired in the processing in S73 by referring to the execution status information 132 acquired in the processing in S62 (S74).

Then, the scheduling unit 114 determines whether all jobs have been acquired in the processing in S73 (S75).

As a result, when it is determined that not all jobs have been acquired in the processing in S73 (NO in S75), the scheduling unit 114 performs S73 and the subsequent process again.

Meanwhile, when it is determined that all jobs have been acquired in the processing in S73 (YES in S75), the scheduling unit 114 ends the second scheduling process.

When it is determined that all jobs have been acquired in the processing in S73 (YES in S75), the scheduling unit 114 may generate the schedule information 134 indicating the result of scheduling performed in the processing in S74. Then, in this case, the information transmitter 115 may transmit the schedule information 134 generated by the scheduling unit 114, to the job execution device 3.

Accordingly, the job execution device 3 is capable of executing jobs according to the job scheduling performed by the scheduling unit 114.

As described above, the information processing apparatus 1 in the embodiment stores a plurality of jobs in a plurality of queues, according to maximum execution times of a plurality of execution target jobs. Then, the information processing apparatus 1 divides the plurality of queues into a plurality of groups, according to the numbers of nodes used when the plurality of jobs is executed.

Subsequently, the information processing apparatus 1 specifies second queues (prioritized queues or normal queues) which are queues other than a first queue with a high priority (a most prioritized queue) among the queues included in each group among the groups in each time zone among time zones included in the time when the plurality of jobs is executed. Then, in each of the time zones, the information processing apparatus 1 determines the priority of the second queues to be different priorities lower than the priority of the first queue, for the groups, respectively.

Then, the information processing apparatus 1 determines the execution timings of queues included in the plurality of groups, based on the priorities corresponding to the plurality of groups, in each of the time zones.

That is, before determining the execution order of jobs, the information processing apparatus 1 distributes (stores) the jobs to (in) a plurality of queues according to the maximum execution time and the number of execution nodes of each job. Then, the information processing apparatus 1 performs scheduling on the execution timings of the jobs stored in each queue according to the priorities of each queue determined according to the time zones.

Accordingly, the information processing apparatus 1 is capable of performing scheduling in which the turnaround time of a job can be shortened in a required time zone. Specifically, for example, the information processing apparatus 1 is capable of performing scheduling in which the turnaround time of a job can be shortened within working hours of each worker.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored a job scheduling program that causes a computer to execute a process, the process comprising:
storing a plurality of jobs to be executed in a plurality of queues according to maximum execution times of the plurality of jobs and numbers of nodes used when the plurality of jobs are executed;
dividing the plurality of queues into a plurality of groups according to the numbers of nodes;
specifying second queues which are queues other than a first queue with a high priority among the plurality of queues included in each of the plurality of groups in each of a plurality of time zones included in a time zone during which the plurality of jobs are executed;
determining, in each of the plurality of time zones, a priority of the second queues to be different priorities lower than a priority of the first queue, for the plurality of groups, respectively;
calculating, for each of the plurality of queues, a first progress value that indicates a progress status of execution of the plurality of jobs stored in each queue, based on a first value which is a number of the plurality of jobs to have stored in each queue in a predetermined time zone, and a second value which is a number of the plurality of jobs to have executed in the predetermined time zone; and
determining execution timings of the plurality of jobs stored in the plurality of queues, respectively, in each of the plurality of time zones, based on priorities that correspond to the plurality of queues, and an order in which the plurality of jobs are stored in the plurality of queues, when at least one of second progress values that indicate progress statuses that correspond to the plurality of queues included in a group that has a higher priority of the second queues than other groups among the plurality of groups is less than a first threshold value.

2. The non-transitory computer-readable recording medium according to claim 1,
wherein, in the storing of the plurality of jobs in the plurality of queues,
a job of the plurality of jobs with the maximum execution time equal to or greater than a second threshold value, and a job of the plurality of jobs with the maximum execution time less than the second threshold value are stored in different queues of the plurality of queues.

3. The non-transitory computer-readable recording medium according to claim 1,
wherein, in the dividing of the plurality of queues into the plurality of groups,
queues in which the number of nodes is equal to or greater than a third threshold value and queues in which the number of nodes is less than the third threshold value are classified into different groups.

4. The non-transitory computer-readable recording medium according to claim 1,
wherein, in the calculating of the first progress value,
the first progress value is calculated by diving the second value by the first value.

5. The non-transitory computer-readable recording medium according to claim 1,
wherein, in the determining of the execution timings,
when at least one of the second progress values is less than the first threshold value,
a predetermined number of jobs is extracted from each of the second queues in the plurality of groups in an order of storage in each of the plurality of queues, from old of the order, and
the execution timings of the plurality of jobs stored in the first queue included in the plurality of groups, respectively, and the execution timings of the predetermined number of jobs extracted from each of the second queues in the plurality of groups are determined.

6. The non-transitory computer-readable recording medium according to claim 5,
wherein, in the determining of the execution timings,
the execution timings of the plurality of jobs stored in the first queues included in the plurality of groups, respectively, are prior to the execution timings of the predetermined number of jobs extracted from each of the second queues in the plurality of groups, and
each of the execution timings of the predetermined number of jobs extracted from each of the second queues in the plurality of groups follows an order of storage in the second queues in the plurality of groups.

7. The non-transitory computer-readable recording medium according to claim 1,
wherein, in the determining of the execution timings,
when all of the second progress values are equal to or greater than the first threshold value,
the execution timings included in a group with a relatively high priority among the plurality of groups are prior to the execution timings included in a group with a relatively low priority, in each of the plurality of time zones.

8. The non-transitory computer-readable recording medium according to claim 1,
wherein processes that include the storing of the plurality of jobs, the dividing of the plurality of queues, the specifying of the second queues, the determining of the priority of the second queues, the calculating of the first progress value, and the determining of the execution timings are repeatedly performed, and
in the determining of the execution timings,
when all of the second progress values are equal to or greater than the first threshold value, whether at least one of the second progress values is less than the first threshold value is determined,
when at least one of the second progress values is less than the first threshold value, the execution timings are determined based on the priorities that correspond to the queues, and the order in which the plurality of jobs are stored in the plurality of queues, in each of the plurality of time zones, and
when all of the second progress values are equal to or greater than the first threshold value, the execution timings included in a group with a relatively high priority among the plurality of groups are prior to the execution timings included in a group with a relatively low priority, in each of the plurality of time zones.

9. The non-transitory computer-readable recording medium according to claim 8,
wherein, in the determining of the execution timings,
when at least one of the second progress values is less than the first threshold value, or when at least one of the second progress values is less than a fourth threshold value, whether at least one of the second progress values is less than the fourth threshold value is determined,
when all of the second progress values are equal to or greater than the fourth threshold value, whether at least one of the second progress values is less than the first threshold value is determined,
when at least one of the second progress values is less than the first threshold value, the execution timings are determined based on the priorities that correspond to the plurality of queues, and the order in which the plurality of jobs are stored in the plurality of queues, in each of the plurality of time zones, and
when all of the second progress values are equal to or greater than the first threshold value, the execution timings are determined, in each of the plurality of time zones, such that the execution timings of the plurality of jobs stored in the plurality of queues included in the group with the relatively high priority among the plurality of groups are prior to the execution timings of the plurality of jobs stored in the plurality of queues included in the group with the relatively low priority.

10. The non-transitory computer-readable recording medium according to claim 9,
wherein, in the determining of the execution timings,
when at least one of the second progress values is less than the fourth threshold value, the execution timings are determined, in each of the plurality of time zones, based on the priorities corresponding to the plurality of queues, and the order in which the plurality of jobs are stored in the plurality of queues.

11. An information processing apparatus comprising:
a memory; and
a processor coupled to the memory and configured to:
store a plurality of jobs to be executed in a plurality of queues according to maximum execution times of the plurality of jobs and numbers of nodes used when the plurality of jobs are executed;
divide the plurality of queues into a plurality of groups according to the numbers of nodes;
specify second queues which are queues other than a first queue with a high priority among the plurality of queues included in each of the plurality of groups in each of a plurality of time zones included in a time zone during which the plurality of jobs are executed;
determine, in each of the plurality of time zones, a priority of the second queues to be different priorities lower than a priority of the first queue, for the plurality of groups, respectively;
calculate, for each of the plurality of queues, a first progress value that indicates a progress status of execution of the plurality of jobs stored in each queue, based on a first value which is a number of the plurality of jobs to have stored in each queue in a predetermined time zone, and a second value which is a number of the plurality of jobs to have executed in the predetermined time zone; and
determine execution timings of the plurality of jobs stored in the plurality of queues, respectively, in each of the plurality of time zones, based on priorities that correspond to the plurality of queues, and an order in which the plurality of jobs are stored in the plurality of queues, when at least one of second progress values that indicate progress statuses that correspond to the plurality of queues included in a group that has a higher priority of the second queues than other groups among the plurality of groups is less than a first threshold value.

12. The information processing apparatus according to claim 11, when at least one of the second progress values is less than the first threshold value,
a predetermined number of jobs is extracted from each of the second queues in the plurality of groups in an order of storage in each of the plurality of queues, from old of the order, and
the execution timings of the predetermined number of jobs extracted from each of the second queues in the plurality of groups are determined.

13. The information processing apparatus according to claim 11,
when all of the second progress values are equal to or greater than the first threshold value,
the execution timings included in a group with a relatively high priority among the plurality of groups are prior to the execution timings included in a group with a relatively low priority, in each of the plurality of time zones.

14. A job scheduling method that causes a computer to execute a process, the process comprising:
storing a plurality of jobs to be executed in a plurality of queues according to maximum execution times of the plurality of jobs and numbers of nodes used when the plurality of jobs are executed;
dividing the plurality of queues into a plurality of groups according to the numbers of nodes;
specifying second queues which are queues other than a first queue with a high priority among the plurality of queues included in each of the plurality of groups in each of a plurality of time zones included in a time zone during which the plurality of jobs are executed;
determining, in each of the plurality of time zones, a priority of the second queues to be different priorities lower than a priority of the first queue, for the plurality of groups, respectively;
calculating, for each of the plurality of queues, a first progress value that indicates a progress status of execution of the plurality of jobs stored in each queue, based on a first value which is a number of the plurality of jobs to have stored in each queue in a predetermined time zone, and a second value which is a number of the plurality of jobs to have executed in the predetermined time zone; and
determining execution timings of the plurality of jobs stored in the plurality of queues, respectively, in each of the plurality of time zones, based on priorities that correspond to the plurality of queues, and an order in which the plurality of jobs are stored in the plurality of queues, when at least one of second progress values that indicate progress statuses that correspond to the plurality of queues included in a group that has a higher priority of the second queues than other groups among the plurality of groups is less than a first threshold value.

15. The job scheduling method according to claim 14,
when at least one of the second progress values is less than the first threshold value,
a predetermined number of jobs is extracted from each of the second queues in the plurality of groups in an order of storage in each of the plurality of queues, from old of the order, and
the execution timings of the predetermined number of jobs extracted from each of the second queues in the plurality of groups are determined.

16. The job scheduling method according to claim 14,
when all of the second progress values are equal to or greater than the first threshold value,
the execution timings included in a group with a relatively high priority among the plurality of groups are prior to the execution timings included in a group with a relatively low priority, in each of the plurality of time zones.
